(19) United States
(12) Patent Application Publication
(10) Pub. No.: US 2022/0261336 A1
(43) Pub. Date: Aug. 18, 2022

(54) BUILDING, TRAINING, AND MAINTAINING AN ARTIFICIAL INTELLIGNECE-BASED FUNCTIONL TESTING TOOL

(71) Applicant: MICRO FOCUS LLC, Santa Clara, CA (US)

(72) Inventors: Eyal Luzon, Yehud (IL); Dror Saaroni, Yehud (IL); Tsachi Ben zur, Yehud (IL); Yonathan Livny, Yehud (IL)

(21) Appl. No.: 17/176,944

(22) Filed: Feb. 16, 2021

(51) Int. Cl. G06F 11/36; G06N 20/00

(52) U.S. Cl. CPC G06F 11/3688; G06N 20/00; G06F 11/3664

(57) ABSTRACT

Embodiments of the disclosure provide systems and methods for functional testing of an application based on evaluation of contents of a user interface of the application using artificial intelligence. Performing functional testing on an Application Under Test (AUT) can comprise building a model defining each of a plurality of object classifications for objects of a user interface of the AUT based on a graphical appearance of the objects. Objects in an image of the user interface can be identified based on the plurality of object classifications defined in the model and the graphical appearance of each of the one or more objects in the image. A test script defining one or more functional tests can then be executing on the AUT. Executing the test script can comprise performing the one or more functional tests on the AUT based on the identified one or more objects in the image.

### FIELD OF THE DISCLOSURE

Embodiments of the present disclosure relate generally to methods and systems for functional testing of an application and more particularly to automated functional testing of an application based on evaluation of contents of a user interface of the application using artificial intelligence.

### BACKGROUND

The development lifecycle of a software application is an iterative process of development and testing. To find defects in the application as early as possible, automatic functional testing is used. Automated functional testing traditionally employs an automation script which consists of operations to be performed on the Application Under Test (AUT). These operations are operating on the AUT at a user level, i.e. testing the application through a user interface of the application, and normally have two parts: identifying the requested control in the interface of the application; and performing the desired operation on the identified control. Traditional identification processes are based on the underlying technological properties of the object. These properties are requested to have certain values in order to properly identify the object. However, these properties may be changed, causing the test to fail. Hence, there is a need for improved methods and systems for functional testing of an application.

### BRIEF SUMMARY

Embodiments of the disclosure provide systems and methods for functional testing of an application based on evaluation of contents of a user interface of the application using artificial intelligence. According to one embodiment, a method for performing functional testing on an Application Under Test (AUT) can comprise building a model defining each of a plurality of object classifications for objects of a user interface of the AUT based on a graphical appearance of the objects. Building the model can comprise receiving a set of images, each image of the set of images comprising an image of a user interface of a plurality of user interfaces and representing the one or more objects of the user interface. Each object in each image of the set of images can be tagged and assigned to either a training data set of the model or a validation data set of the model. Assigning each image to either the training data set or the validation data set can further comprise balancing the training data set and the validation data set. The model can then be trained based on the training data set and validated based on the validation data set.

Tagging each object in each image of the set of images can comprise assigning a tag to each object in each image of the set of images and removing from the objects of the set of images any object having a size less than a predefined object size. Additionally, or alternatively, tagging each object in each image of the set of images can comprise evaluating graphical characteristics of each image of the set of images and removing objects from the set of images based on the evaluating of the graphical characteristics of the images. Tagging each object in each image of the set of images can additionally, or alternatively, comprise determining whether more than one tag is defined for an object and, in response to determining more than one tag is defined for the object, removing all tags for the object other than a first tag. Additionally, or alternatively, tagging each object in each image of the set of images can comprise determining whether an object within a bounding box for the image is tagged more than once and, in response to determining the image within the bounding box is tagged more than once, removing all tags for the object other than a first tag. Tagging each object in each image of the set of images can additionally, or alternatively, comprise truncating a portion of each image outside of a bounding box for the image.

One or more objects in an image of the user interface of the AUT can be identified based on the plurality of object classifications defined in the model and the graphical appearance of each of the one or more objects in the image of the user interface of the AUT. Identifying the one or more objects in the image of the user interface of the AUT can comprise identifying an object type for an object of the one or more objects based on matching the graphical appearance of the object to one of the plurality of object classifications defined in the model, scoring the match between the graphical appearance of the object and the one of the plurality of object classifications defined in the model, and determining whether the scored match between the graphical appearance of the object and the one of the plurality of object classifications defined in the model indicates a successful identification of the object. In response to determining the scored match between the graphical appearance of the object and the one of the plurality of object classifications defined in the model indicates successful identification of the object, the object can be classified based on the match. In response to determining the scored match between the graphical appearance of the object and the one of the plurality of object classifications defined in the model does not indicate successful identification of the object, one or more properties of the object can be evaluated and a determination can be made as to whether the one or more properties of the object confirm identification of the object type for the object based on one or more corresponding properties for the one of the plurality of object classifications defined in the model. In response to determining the one or more properties of the object confirm identification of the object type for the object based on one or more corresponding properties for the one of the plurality of object classifications defined in the model, the scored match between the graphical appearance of the object and the model can be increased and the object can be classified based on the match.

A test script defining one or more functional tests can then be executed on the AUT. Executing the test script can comprise performing the one or more functional tests on the AUT based on the identified one or more objects in the image of the user interface of the AUT. In some cases, the model can be retrained based on results of identifying the one or more object in the image of the user interface of the AUT.

According to another embodiment, a system can comprise a processor and a memory coupled with and readable by the processor. The memory can have stored therein a set of instructions which, when executed by the processor, causes the processor to perform functional testing on an AUT by building a model defining each of a plurality of object classifications for objects of a user interface of the AUT based on a graphical appearance of the objects, identifying one or more objects in an image of the user interface of the AUT based on the plurality of object classifications defined in the model and the graphical appearance of each of the one or more objects in the image of the user interface of the AUT, and executing a test script defining one or more functional tests on the AUT. Executing the test script can comprise performing the one or more functional tests on the AUT based on the identified one or more objects in the image of the user interface of the AUT. The instruction can further cause the processor to retrain the model based on results of identifying the one or more object in the image of the user interface of the AUT.

Building the model can comprise receiving a set of images. Each image of the set of images can comprise an image of a user interface of a plurality of user interfaces and can represent the one or more objects of the user interface. Each object in each image of the set of images can be tagged. Each image of the set of images can be assigned to either a training data set of the model or a validation data set of the model. Assigning each image to either the training data set or the validation data set can further comprise balancing the training data set and the validation data set. The model can then be trained based on the training data set and validated based on the validation data set.

Identifying the one or more objects in the image of the user interface of the AUT can comprise identifying an object type for an object of the one or more objects based on matching the graphical appearance of the object to one of the plurality of object classifications defined in the model. The match between the graphical appearance of the object and the one of the plurality of object classifications defined in the model can be scored and a determination can be made as to whether the scored match between the graphical appearance of the object and the one of the plurality of object classifications defined in the model indicates a successful identification of the object. In response to determining the scored match between the graphical appearance of the object and the one of the plurality of object classifications defined in the model indicates successful identification of the object, the object can be classified based on the match. In response to determining the scored match between the graphical appearance of the object and the one of the plurality of object classifications defined in the model does not indicate successful identification of the object, one or more properties of the object can be evaluated and a determination can be made as to whether the one or more properties of the object confirm identification of the object type for the object based on one or more corresponding properties for the one of the plurality of object classifications defined in the model. In response to determining the one or more properties of the object confirm identification of the object type for the object based on one or more corresponding properties for the one of the plurality of object classifications defined in the model, the scored match between the graphical appearance of the object and the model can be increased and the object can be classified based on the match.

According to yet another embodiment, a non-transitory, computer-readable medium can comprise a set of instructions stored therein which, when executed by the processor, causes the processor to perform functional testing on an Application Under Test (AUT) by building a model defining each of a plurality of object classifications for objects of a user interface of the AUT based on a graphical appearance of the objects, identifying one or more objects in an image of the user interface of the AUT based on the plurality of object classifications defined in the model and the graphical appearance of each of the one or more objects in the image of the user interface of the AUT, and executing a test script defining one or more functional tests on the AUT. Executing the test script can comprise performing the one or more functional tests on the AUT based on the identified one or more objects in the image of the user interface of the AUT. The instruction can further cause the processor to retrain the model based on results of identifying the one or more object in the image of the user interface of the AUT.

Building the model can comprise receiving a set of images. Each image of the set of images can comprise an image of a user interface of a plurality of user interfaces and can represent the one or more objects of the user interface. Each object in each image of the set of images can be tagged. Each image of the set of images can be assigned to either a training data set of the model or a validation data set of the model. Assigning each image to either the training data set or the validation data set can further comprise balancing the training data set and the validation data set. The model can then be trained based on the training data set and validated based on the validation data set.

Identifying the one or more objects in the image of the user interface of the AUT can comprise identifying an object type for an object of the one or more objects based on matching the graphical appearance of the object to one of the plurality of object classifications defined in the model. The match between the graphical appearance of the object and the one of the plurality of object classifications defined in the model can be scored and a determination can be made as to whether the scored match between the graphical appearance of the object and the one of the plurality of object classifications defined in the model indicates a successful identification of the object. In response to determining the scored match between the graphical appearance of the object and the one of the plurality of object classifications defined in the model indicates successful identification of the object, the object can be classified based on the match. In response to determining the scored match between the graphical appearance of the object and the one of the plurality of object classifications defined in the model does not indicate successful identification of the object, one or more properties of the object can be evaluated and a determination can be made as to whether the one or more properties of the object confirm identification of the object type for the object based on one or more corresponding properties for the one of the plurality of object classifications defined in the model. In response to determining the one or more properties of the object confirm identification of the object type for the object based on one or more corresponding properties for the one of the plurality of object classifications defined in the model, the scored match between the graphical appearance of the object and the model can be increased and the object can be classified based on the match.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating components of an exemplary functional testing environment according to one embodiment of the present disclosure.

FIG. 4 is a flowchart illustrating an exemplary process for performing functional testing on an application according to one embodiment of the present disclosure.

FIG. 5 is a flowchart illustrating an exemplary process for building model data sets according to one embodiment of the present disclosure.

FIG. 6 is a flowchart illustrating an exemplary process for tagging image objects according to one embodiment of the present disclosure.

FIG. 7 is a flowchart illustrating an exemplary process for performing object identification according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programmable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

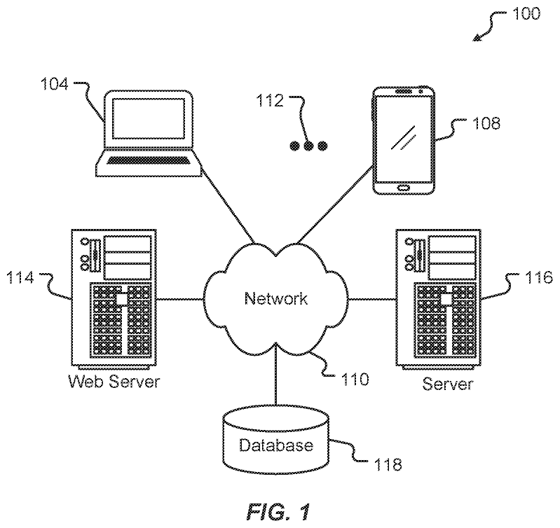

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

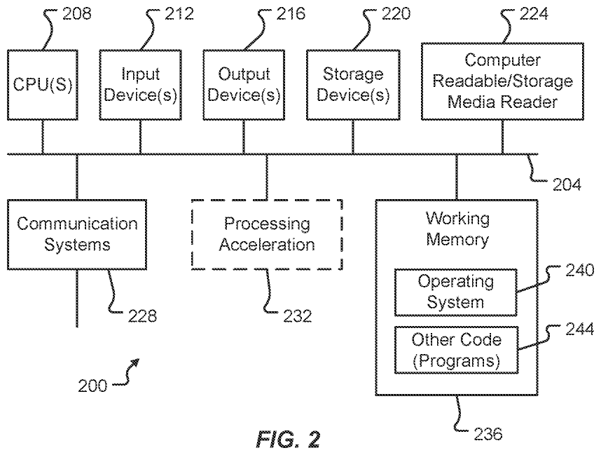

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

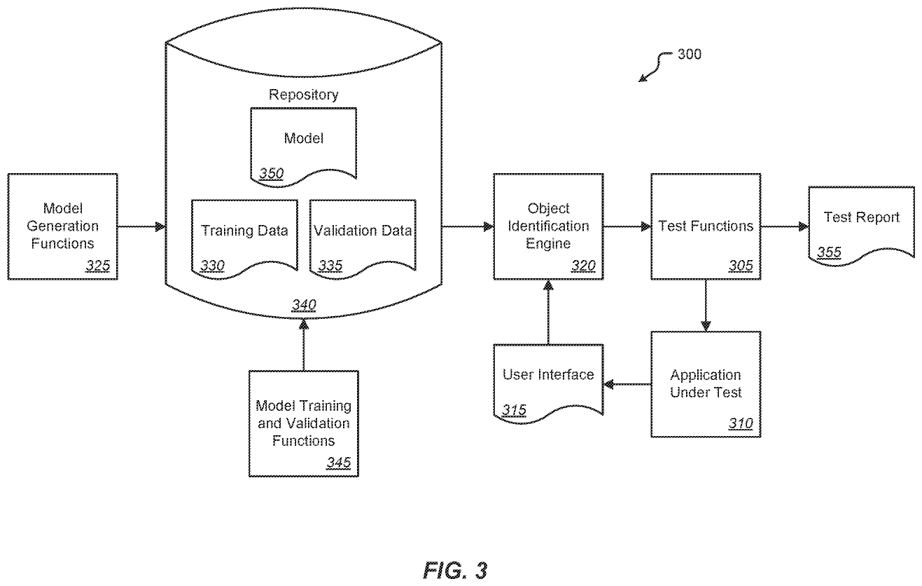

FIG. 3 is a block diagram illustrating components of an exemplary functional testing environment according to one embodiment of the present disclosure. More specifically, this example illustrates a test system 300 such as may be implemented on any one or more servers or other computing devices as described above. Generally speaking, the test system 300 can execute one or more testing functions 305 to perform functional testing on an Application Under Test (AUT) 310. The test functions 305 can operate based on a user interface 315 of the AUT and objects, e.g., links, buttons, icons, and/or other elements, within the user interface 315 identified by an object identification engine 320. As will be described, the object identification engine 320 can utilize Artificial Intelligence (AI) to identify objects in the user interface 315 of the AUT 310 based on their graphical appearance, like a human, rather than their underlying technological properties. Once objects on user interface 315 page or screen have been identified by the AI processes of the object identification engine 320, a training script or application that defines the test functions 305 can be executed to automatically test the AUT 310 based on the object identification and/or classification. The AI used by the object identification engine 320 to graphically/visually identify objects may be trained on data that graphically/visually identifies other objects, not necessarily those objects in the user interface 315 of the AUT 310. For instance, a login button on one screen of one application, e.g., a website, often has similar graphical characteristics as a login button for some other application, e.g., a mobile application, and can be the basis of identifying a login button object in the user interface 315 of the AUT 310.

Accordingly, the test system 300 can further comprise a set of model generation functions 325. As will be described, the model generation functions 325 can execute to generate a set of training data 335 and validation data 340, which may be saved in one or more databases or other repositories 345. The test system 300 can also include a set of model training and validation functions 345 which can use the training data set 330 and validation data set 335 to respectively train and validate a model 350. The model 350 can define graphical and/or visual characteristics of objects which can be used by the object identification engine 320 to identify and classify objects of the user interface 315 of the AUT 310.

Training of the model 350 by the model training and validation functions 345 can be done on tagged images, i.e., images of the user interface 315 of the AUT 310 in which objects are tagged and identified. As part of the training, these tagged images can be split between the training data 330 and the validation data, which allows the training to internally validate itself as part of the training process. According to one embodiment, the tagged image data provided by the model generation functions 325 can be balanced between the training data 330 and the validation data 335. One way to balance the image data can be to split it between the training data 330 and validation data 335 in a random way. The random split helps to have two datasets that are not biased. However, a random split may result in undesired bias when applied to classes with fewer occurrences. According to one embodiment, to split and balance the image data between the training data 330 can the validation data 335, the model generation functions 325 can use a scoring algorithm to measure how balanced each class is for each random split option. Therefore, in order to continue and improve the balanced split between the training data 330 and validation data 335, the model generation functions 325 can receive an image set and for each image in the image set, determine whether the image is to be assigned to the training data set 330 or to a validation data set 335 based on whether the assignment to one or the other makes the split score lower.

Tags can be applied to images in the training data 330 and/or the validation data 335 either manual by a user or by the model generation functions based on a model 350 if already trained. Either approach can cause inconsistencies and other issues, e.g., if the model 350 is not yet trained or the new images are significantly different from what the model 350 has been trained on. These inconsistencies and other issues can be addressed by some additional steps. For example, prior to executing model training by the model training and validation functions 345, small objects can be removed from the training data 330 and/or validation data 335. This can be determined by a bounding box set for each object. If the bounding box is too small, i.e., the object is less than a predetermined size, it can be removed from the training data 330 and/or validation data 335. Additionally, or alternatively, “empty” objects can be removed. For example, based on image-based algorithms like color distribution or image histogram a decision can be made as to whether the box that was tagged contains any graphical or visual content. In case it does not contain anything, the object can be removed from the training data 330 and/or validation data 335. In some cases, multiple tagging can additionally, or alternatively, be detected and removed from the training data 330 and/or validation data 335. For example, if a machine learning algorithm is being used that does not support more than tag per object, any tags more than one can be removed for that object. Additionally, or alternatively, overlapping tags, i.e., move than one tag applied to an object within the same bounding box, can be removed from the training data 330 and/or validation data 335. In some cases, objects that exceed or go beyond the image size can be truncated.

Once the training data 330 and validation data 335 has been prepared, the model 350 can be trained and validated by the model training and validation functions 345. This can be accomplished using any of a variety of available machine learning algorithms. For example, a Deep Neural Network (DNN) can be used for object detection such as the Single Shot multibox Detector (SSD) architecture publish by Google. Once trained and validated, the model can be used by the object identification engine 320 to identify objects in the user interface 315 of the AUT 310 based on their graphical or visual appearance. Tests executed by the test functions 305 can be based on the objects identified by the object identification engine 320. Results of the tests can be provided in one or more printed, displayed, or saved test reports 355.

Functional test contains flows that mimic a user's usage of the AUT, e.g., based on the user's interaction with and/or navigation through the user interface 315 of the AUT 310. These flows contain various operations and applications screens. For example, consider the online shopping scenario where the user may select the product, customize the product, enter payment information, enter a shipping address, etc. When the test functions 305 are executed to perform the automated functional tests on the AUT 310, they rely on an accurate identification of objects by the object identification engine 320. However, when using AI to perform visual/graphical based identification methods, there can a problem identifying all the elements on the screen. For example, the identified object class might have a low confidence score so the object will be identified incorrectly, or not be identified at all, and the test will not be able to continue.

According to one embodiment, when the object identification engine 320 cannot correctly identify the object, meaning the object is getting a low score which shows that the model is not certain about its identification, the object can be further evaluated by its underlying properties. For example, the object identification engine 320 can then evaluate the properties of the underlying object, e.g., the Document Object Model (DOM) element. If the object identification engine 320 finds that the properties of the object match expected properties for the object identified based on its appearance, then the object identification engine 320 can increase the confidence score for that object over using the image analysis as the sole mechanism used to identify the object. For example, in case of a setting icon, the properties of the underlying tech object can provide some hints that this is a setting button. These hints may be included in the title of the object, the tooltip or even in a text that is used for screen readers. All this information is technological information that exist in the underlying layer and can be used to increase the certainty of the identified object. To maintain efficiency, however, it may not be desirable to always consider the underlying tech object when performing object classification. Rather, if a suitable confidence score is obtained based on AI alone, then the object identification engine 320 may assign the class to the object without performing a further analysis of the underlying tech object.

According to one embodiment, when the object identification engine 320 cannot identify an object, knowledge obtained from a previous screen in the same flow can be used. That is, when an element is not found on a particular screen or page of the user interface 315, but is expected on that screen or page, the object identification engine 320 can check if the current screen or page has any similarities to a previous screen or page. If a similarity exists, then the object identification engine 320 can further check if the object, or a similar looking object, exists in the previous screen or page. If one such object is found, the object identification engine 320 may then assume that the object also exists in the current screen and information for the object can be updated to match the information from the similar object in the previous screen.

According to one embodiment, misidentification of objects by the object identification engine 320 or extra identification of non-interesting areas can be reduced by masking and/or cropping-out non-interesting areas of the user interface 315 for functional testing. By cropping these areas, the object identification engine 320 can reduce the time for inference since results are located only in responsive area of the user interface 315. Identification of non-interesting areas can be done by various capabilities like Threshold Continuous Selection or Focus Area. These methods check the behavior of the image and identifies the areas that can be cropped or masked. This approach helps to focus the object identification engine's 320 image analysis, i.e., object identification and Optical Character Recognition (OCR), on the areas of interest and not waste time on non-relevant areas. It helps to simplify the use of the object identification engine 320 and allow the object identification engine 320 to focus on what the tester expects it to focus on. This can reduce the computation time and can provide better results.

Functional testing of the AUT 310 typically involves executing regression tests over and over in order to verify that the application is not harmed due to developer's changes. This means that for each change of the developer a regression test is being executed and is doing basically the same as it did in the previous execution. According to one embodiment, the already existing identification of objects from the previous executions can be used in order reduce the amount of time it takes to identify objects in the current execution.

In such embodiments, when the test functions 305 execute a step and call the object identification engine 320 for object identification, the result, the step, and a hash of the image can be stored by the test functions. When a test is going to execute, the test functions 305 can check if the same step was already executed before and has an identification. In case it was executed, the current image can be compared to the cached image and in case the images are similar the already existing identification information can be used instead of calling the object identification engine 320. As the tests are being executed over and over, the images will be similar so we can enjoy this already existing identification. According to one embodiment, the caching used can be a full hash comparing an exact match of the image or can be based on features extracted from the image. In some cases, the image may not be bound to a specific step but rather, one image can be stored for multiple steps.

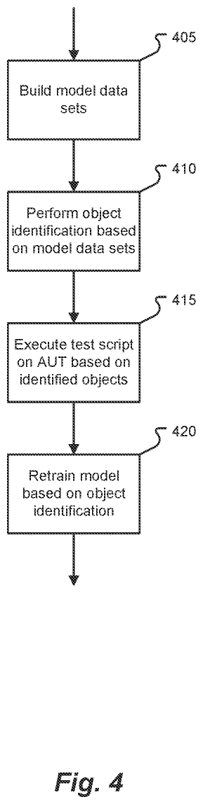

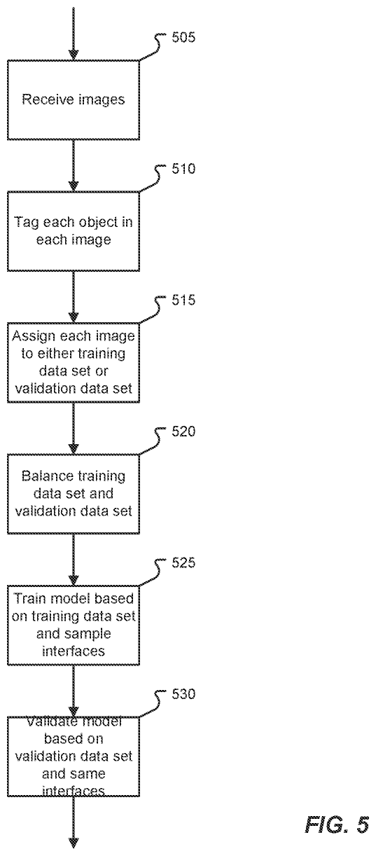

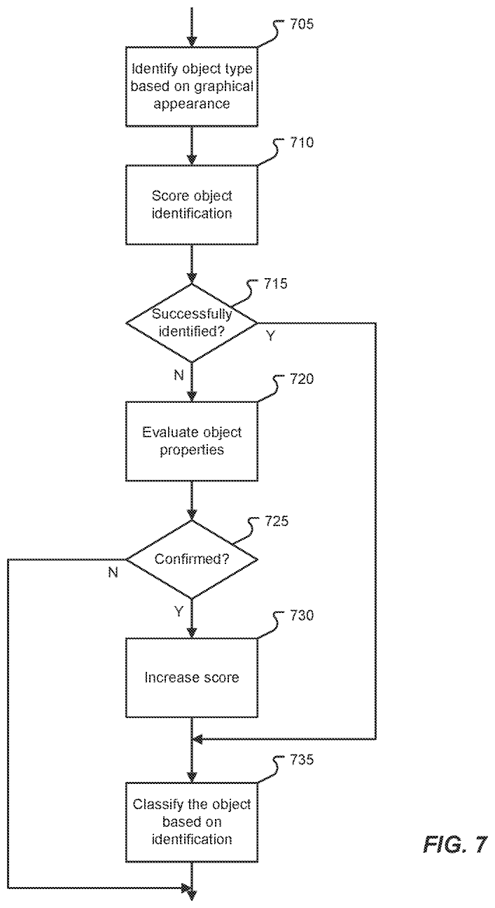

FIG. 4 is a flowchart illustrating an exemplary process for performing functional testing on an application according to one embodiment of the present disclosure. As illustrated in this example, performing functional testing on an AUT can begin with building 405 a model defining each of a plurality of object classifications for objects of a user interface of the AUT based on a graphical appearance of the objects. An exemplary process for building 405 the model will be described below with reference to FIG. 5. One or more objects in an image of the user interface of the AUT can be identified 410 based on the plurality of object classifications defined in the model and the graphical appearance of each of the one or more objects in the image of the user interface of the AUT. An exemplary process for identifying 410 objects in an image of the user interface of the AUT will be described below with reference to FIG. 7. A test script defining one or more functional tests can then be executed 415 on the AUT. Executing 415 the test script can comprise performing the one or more functional tests on the AUT based on the identified one or more objects in the image of the user interface of the AUT. In some cases, the model can be retrained 420 based on results of identifying the one or more object in the image of the user interface of the AUT.

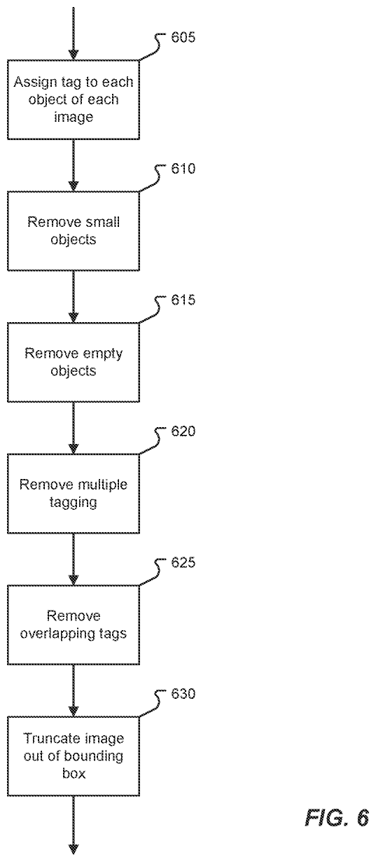

FIG. 5 is a flowchart illustrating an exemplary process for building model data sets according to one embodiment of the present disclosure. As illustrated in this example, building the model can comprise receiving 505 a set of images. Each image of the set of images can comprise an image of a user interface of a plurality of user interfaces and can represent the one or more objects of the user interface. For example, the plurality of user interfaces can comprise interfaces of one or more previously tested application or any other interface used to train the model. Each object in each image of the set of images can be tagged 510. An exemplary process for tagging each object will be described below with reference to FIG. 6. Each image of the set of images can be assigned 515 to either a training data set of the model or a validation data set of the model. Assigning 515 each image to either the training data set or the validation data set can further comprise balancing 520 the training data set and the validation data set as described above. The model can then be trained 525 based on the training data set and validated 530 based on the validation data set also as described above.

FIG. 6 is a flowchart illustrating an exemplary process for tagging image objects according to one embodiment of the present disclosure. As illustrated in this example, tagging each object in each image of the set of images can comprise manually or automatically assigning 605 a tag to each object in each image of the set of images and removing 610 from the objects of the set of images any object having a size less than a predefined object size. Additionally, or alternatively, tagging each object in each image of the set of images can comprise removing 615 visually or graphically empty objects, i.e., evaluating graphical characteristics of each image of the set of images and removing objects from the set of images based on the evaluating of the graphical characteristics of the images. Tagging each object in each image of the set of images can additionally, or alternatively, comprise removing 620 multiple tagging on objects, i.e., determining whether more than one tag is defined for an object and, in response to determining more than one tag is defined for the object, removing all tags for the object other than a first tag. Additionally, or alternatively, tagging each object in each image of the set of images can comprise removing 625 any overlapping tags, i.e., determining whether an object within a bounding box for the image is tagged more than once and, in response to determining the image within the bounding box is tagged more than once, removing all tags for the object other than a first tag. Tagging each object in each image of the set of images can additionally, or alternatively, comprise truncating 630 a portion of each image outside of a bounding box for the image.

FIG. 7 is a flowchart illustrating an exemplary process for performing object identification according to one embodiment of the present disclosure. As illustrated in this example, identifying the one or more objects in the image of the user interface of the AUT can comprise identifying 705 an object type for an object of the one or more objects based on matching the graphical appearance of the object to one of the plurality of object classifications defined in the model. The match between the graphical appearance of the object and the one of the plurality of object classifications defined in the model can be scored 710, e.g., a confidence score can be assigned based on a degree of match etc. A determination 715 can then be as to whether the scored match between the graphical appearance of the object and the one of the plurality of object classifications defined in the model indicates a successful identification of the object, e.g., based on the score exceeding a predefined threshold. In response to determining 715 the scored match between the graphical appearance of the object and the one of the plurality of object classifications defined in the model indicates successful identification of the object, the object can be classified 735 based on the match, i.e., assigned a type based on the matching classification in the model.

In response to determining 715 the scored match between the graphical appearance of the object and the one of the plurality of object classifications defined in the model does not indicate successful identification of the object, one or more properties of the object can be evaluated 720 and a determination 725 can be made as to whether the one or more properties of the object confirm identification of the object type for the object based on one or more corresponding properties for the one of the plurality of object classifications defined in the model. In response to determining 725 the one or more properties of the object confirm identification of the object type for the object based on one or more corresponding properties for the one of the plurality of object classifications defined in the model, the scored match between the graphical appearance of the object and the model can be increased 730 and the object can be classified 735 based on the match.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for performing functional testing on an Application Under Test (AUT), the method comprising:
building, by a test system, a model defining each of a plurality of object classifications for objects of a user interface of the AUT based on a graphical appearance of the objects;
identifying, by the test system, one or more objects in an image of the user interface of the AUT based on the plurality of object classifications defined in the model and the graphical appearance of each of the one or more objects in the image of the user interface of the AUT; and
executing, by the test system, a test script defining one or more functional tests on the AUT, wherein executing the test script comprises performing the one or more functional tests on the AUT based on the identified one or more objects in the image of the user interface of the AUT.

2. The method of claim 1, further comprising retraining, by the test system, the model based on results of identifying the one or more object in the image of the user interface of the AUT.

3. The method 1, wherein building the model comprises:
receiving a set of images, each image of the set of images comprising an image of a user interface of a plurality of user interfaces and representing the one or more objects of the user interface;
tagging each object in each image of the set of images;
assigning each image of the set of images to either a training data set of the model or a validation data set of the model, wherein assigning each image to either the training data set or the validation data set further comprises balancing the training data set and the validation data set;
training the model based on the training data set; and
validating the model based on the validation data set.

4. The method of claim 3, wherein tagging each object in each image of the set of images further comprises:
assigning a tag to each object in each image of the set of images; and
removing from the objects of the set of images any object having a size less than a predefined object size.

5. The method of claim 4, wherein tagging each object in each image of the set of images further comprises evaluating graphical characteristics of each image of the set of images and removing objects from the set of images based on the evaluating of the graphical characteristics of the images.

6. The method of claim 4, wherein tagging each object in each image of the set of images further comprises determining whether more than one tag is defined for an object and, in response to determining more than one tag is defined for the object, removing all tags for the object other than a first tag.

7. The method of claim 4, wherein tagging each object in each image of the set of images further comprises determining whether an object within a bounding box for the image is tagged more than once and, in response to determining the image within the bounding box is tagged more than once, removing all tags for the object other than a first tag.

8. The method of claim 4, wherein tagging each object in each image of the set of images further comprises truncating a portion of each image outside of a bounding box for the image.

9. The method of claim 1, wherein identifying the one or more objects in the image of the user interface of the AUT comprises:
identifying an object type for an object of the one or more objects based on matching the graphical appearance of the object to one of the plurality of object classifications defined in the model;
scoring the match between the graphical appearance of the object and the one of the plurality of object classifications defined in the model;
determining whether the scored match between the graphical appearance of the object and the one of the plurality of object classifications defined in the model indicates a successful identification of the object; and
in response to determining the scored match between the graphical appearance of the object and the one of the plurality of object classifications defined in the model indicates successful identification of the object, classifying the object based on the match.

10. The method of claim 9, wherein identifying the one or more objects in the image of the user interface of the AUT further comprises, in response to determining the scored match between the graphical appearance of the object and the one of the plurality of object classifications defined in the model does not indicate successful identification of the object:
evaluating one or more properties of the object;
determining whether the one or more properties of the object confirm identification of the object type for the object based on one or more corresponding properties for the one of the plurality of object classifications defined in the model; and
in response to determining the one or more properties of the object confirm identification of the object type for the object based on one or more corresponding properties for the one of the plurality of object classifications defined in the model, increasing the scored match between the graphical appearance of the object and the model and classifying the object based on the match.

11. A system comprising:
a processor; and
a memory coupled with and readable by the processor and storing therein a set of instructions which, when executed by the processor, causes the processor to perform functional testing on an Application Under Test (AUT) by:
building a model defining each of a plurality of object classifications for objects of a user interface of the AUT based on a graphical appearance of the objects;
identifying one or more objects in an image of the user interface of the AUT based on the plurality of object classifications defined in the model and the graphical appearance of each of the one or more objects in the image of the user interface of the AUT; and
executing a test script defining one or more functional tests on the AUT, wherein executing the test script comprises performing the one or more functional tests on the AUT based on the identified one or more objects in the image of the user interface of the AUT.

12. The system of claim 11, wherein the instruction further cause the processor to retrain the model based on results of identifying the one or more object in the image of the user interface of the AUT.

13. The system 11, wherein building the model comprises:
receiving a set of images, each image of the set of images comprising an image of a user interface of a plurality of user interfaces and representing the one or more objects of the user interface;
tagging each object in each image of the set of images;
assigning each image of the set of images to either a training data set of the model or a validation data set of the model, wherein assigning each image to either the training data set or the validation data set further comprises balancing the training data set and the validation data set;
training the model based on the training data set; and
validating the model based on the validation data set.

14. The system of claim 11, wherein identifying the one or more objects in the image of the user interface of the AUT comprises:
identifying an object type for an object of the one or more objects based on matching the graphical appearance of the object to one of the plurality of object classifications defined in the model;
scoring the match between the graphical appearance of the object and the one of the plurality of object classifications defined in the model;
determining whether the scored match between the graphical appearance of the object and the one of the plurality of object classifications defined in the model indicates a successful identification of the object; and
in response to determining the scored match between the graphical appearance of the object and the one of the plurality of object classifications defined in the model indicates successful identification of the object, classifying the object based on the match.

15. The system of claim 14, wherein identifying the one or more objects in the image of the user interface of the AUT further comprises, in response to determining the scored match between the graphical appearance of the object and the one of the plurality of object classifications defined in the model does not indicate successful identification of the object:
evaluating one or more properties of the object;
determining whether the one or more properties of the object confirm identification of the object type for the object based on one or more corresponding properties for the one of the plurality of object classifications defined in the model; and
in response to determining the one or more properties of the object confirm identification of the object type for the object based on one or more corresponding properties for the one of the plurality of object classifications defined in the model, increasing the scored match between the graphical appearance of the object and the model and classifying the object based on the match.

16. A non-transitory, computer-readable medium comprising a set of instructions stored therein which, when executed by the processor, causes the processor to perform functional testing on an Application Under Test (AUT) by:
building a model defining each of a plurality of object classifications for objects of a user interface of the AUT based on a graphical appearance of the objects;
identifying one or more objects in an image of the user interface of the AUT based on the plurality of object classifications defined in the model and the graphical appearance of each of the one or more objects in the image of the user interface of the AUT; and
executing a test script defining one or more functional tests on the AUT, wherein executing the test script comprises performing the one or more functional tests on the AUT based on the identified one or more objects in the image of the user interface of the AUT.

17. The non-transitory, computer-readable medium of claim 16, wherein the instructions further cause the processor to retrain the model based on results of identifying the one or more object in the image of the user interface of the AUT.

18. The non-transitory, computer-readable medium 16, wherein building the model comprises:
receiving a set of images, each image of the set of images comprising an image of a user interface of a plurality of user interfaces and representing the one or more objects of the user interface;
tagging each object in each image of the set of images;
assigning each image of the set of images to either a training data set of the model or a validation data set of the model, wherein assigning each image to either the training data set or the validation data set further comprises balancing the training data set and the validation data set;
training the model based on the training data set; and
validating the model based on the validation data set.

19. The non-transitory, computer-readable medium of claim 16, wherein identifying the one or more objects in the image of the user interface of the AUT comprises:
identifying an object type for an object of the one or more objects based on matching the graphical appearance of the object to one of the plurality of object classifications defined in the model;
scoring the match between the graphical appearance of the object and the one of the plurality of object classifications defined in the model;
determining whether the scored match between the graphical appearance of the object and the one of the plurality of object classifications defined in the model indicates a successful identification of the object; and
in response to determining the scored match between the graphical appearance of the object and the one of the plurality of object classifications defined in the model indicates successful identification of the object, classifying the object based on the match.

20. The non-transitory, computer-readable medium of claim 19, wherein identifying the one or more objects in the image of the user interface of the AUT further comprises, in response to determining the scored match between the graphical appearance of the object and the one of the plurality of object classifications defined in the model does not indicate successful identification of the object:
evaluating one or more properties of the object;
determining whether the one or more properties of the object confirm identification of the object type for the object based on one or more corresponding properties for the one of the plurality of object classifications defined in the model; and
in response to determining the one or more properties of the object confirm identification of the object type for the object based on one or more corresponding properties for the one of the plurality of object classifications defined in the model, increasing the scored match between the graphical appearance of the object and the model and classifying the object based on the match.
